(19) United States
(12) Patent Application Publication
(10) Pub. No.: US 2009/0170531 A1
(43) Pub. Date: Jul. 2, 2009

(54) Method and apparatus for transmitting meeting opportunity alert messages to users of mobile terminals located in the same geographical area

(76) Inventors: Karl Georg Hampel, New York, NY (US); Suryanarayan Perinkulam, Clinton, NJ (US); Viswanath Poosala, Basking Ridge, NJ (US)

Correspondence Address: Docket Administrator - Room 2F-192;Alcatel-Lucent USA Inc., 600-700 Mountain Avenue, Murray Hill, NJ, 07974, US

(21) Appl. No.: 12/005,520

(22) Filed: Dec. 27, 2007

(51) Int. Cl. H04Q 7/20

(52) U.S. Cl. 455/456.3

(57) ABSTRACT

A LBS (location-based service) in which users equipped with a localizable mobile communication terminal advantageously receive “alert” messages when they have an opportunity to meet someone located in their geographic vicinity and having a profile matching their own profile. In particular, users, who may be associated with a given group of users, can be alerted via their mobile communication terminal when another user with a matching profile, and who may also be associated with the same group of users, is located in the same predetermined geographical area. The alert message may, for example, include the mobile phone number of the other user located in the same geographical area.

### FIELD OF THE INVENTION

The present invention relates generally to the field of location-based services (LBS) and more particularly to a method and apparatus for alerting users of mobile communication terminals when their geographic locations indicate that they have entered into a common geographical area.

### BACKGROUND OF THE INVENTION

As is well known to those skilled in the art, there are two general approaches to the provisioning of location-based services (LBS). These are approaches are known as “pull LBS” and “push LBS”, respectively. In the pull LBS approach, a requestor requests location-relevant information to be sent based on a geographic location of a mobile communication terminal (also known as a “trackee”). The location-relevant information may be the location coordinates of the trackee or any other information associated with the location thereof. Moreover, the requestor and the trackee may, in fact, be the same equipment or person. The location-relevant information may be forwarded to the requester, to the trackee or to a third party (or equipment). For example, a pull LBS may be a service allowing someone (i.e., a requester) to find the location of a friend or a child (i.e., a trackee) at a given time. In another example, a service (called “directory service”) may allow a user (i.e., a trackee) to be informed of events taking place in his or her geographic vicinity.

In the push LBS method, on the other hand, location-relevant information is forwarded to a user when a trackee crosses a boundary (or a “fence”) of a given geographical area (known as the “fence area or the “geofence area”). The location-relevant information is therefore “pushed” automatically to the user—namely, when it becomes available rather than when it has been requested (as it is in pull LBS methods). As such, this method is sometimes referred to as a “fence crossing alert”. In the case of a directory service, for example, local events may be notified to the user upon entering the zone (geofence area) where they take place. In another example used for child tracking services, parents may be alerted when their child leaves a certain zone.

To support LBS with geofencing alerts, each trackee's location has to be determined frequently. There are various ways of performing this location determination, each of which is fully familiar to those of ordinary skill in the art. If the location determination is performed by means of a network-based geolocation technique, such as, for example, cell ID or cell-power triangulation (both of which are fully familiar to those of ordinary skill in the art), each location determination requires the setup of a wireless network-mobile link. The setup of such a link is costly since it uses air-interface capacity (or resource). It is also possible to obtain the trackee's location from the trackee when it is able to determine its location by means of a localization device, such as a GPS device or an assisted GPS (aGPS) device (each of which is also fully familiar to those of ordinary skill in the art). The use of such devices avoids the need to setup wireless network-mobile links (except in case of aGPS, where updates need to be sent by the network to the trackee, albeit with a very low frequency—typically every two hours).

### SUMMARY OF THE INVENTION

In accordance with the principles of the present invention, a new LBS (location-based service) is provided in which users equipped with a localizable mobile communication terminal advantageously receive “alert” messages when they have an opportunity to meet someone located in their geographical vicinity and having a profile matching their own profile. In particular, in accordance with an illustrative embodiment of the present invention, users, who may be associated with a given group of users, can be alerted via their mobile communication terminal when another user with a matching profile, and who may also be associated with the same group of users, is located in the same predetermined geographical area. The alert message may, for example, include the mobile phone number of the other user in the same geographical area.

Specifically, in accordance with one illustrative embodiment of the present invention, a method for providing meeting opportunity alert messages to users of mobile communication terminals associated with user identifiers and whose geographic locations can be determined, each of said users having an associated user identifier and a corresponding user profile, and wherein each of one or more predetermined geographical areas comprise one or more boundaries thereof, comprises the steps of:

(i) identifying one or more boundary crossings, each identified boundary crossing associated with a given user identifier and identified in response to a geographic location of the mobile communication terminal of the user corresponding to the given user identifier having changed from a first side of a boundary of one of said predetermined geographical areas to a second side of said one of said boundaries of said one of said predetermined geographical areas;

(ii) updating a table of user presence, the table of user presence indicating, for each of a plurality of said users, whether that user is in a given one of said predetermined geographical areas, the table of user presence being updated based on said identified boundary crossings;

(iii) determining a pair of users both of which are present in a given geographical area based on the table of user presence;

(iv) comparing the user profiles associated with the users in said pair of users; and

(v) generating a meeting opportunity alert message, for transmission to the mobile communication terminal of at least one user of said pair of users which are present in the given geographical area, if the user profiles associated with the users in said pair of users match.

In accordance with various illustrative embodiments of the invention, the method and apparatus of the present invention may include additional characteristics considered separately or combined, such as, for example:

(a) the table indications may be flags having either a first value indicating that a user is into his associated geographical area or a second value indicating that a user is out of his associated geographical area;

(b) one may generate a crossing alert message designating a user identifier each time the last geographic location of the mobile communication terminal of the corresponding user allows to detect that this user is entered into or has left out of the geographical area to which his user identifier is associated with;

(c) one may generate a crossing alert message comprising a user identifier and a flag whose value is representative either of the entry of the corresponding user into his associated geographical area or of the leaving of the corresponding user out of his associated geographical area;

(d) one may store a n-tuple for each user, each n-tuple comprising a user identifier, a geographical area identifier and a predicate able to take one of two opposite values, and one may modify the current value of the predicate of an n-tuple associated with a user, each time a crossing alert message relative to this user is generated;

(e) one may store a n-tuple for each user, each n-tuple comprising a user identifier, a geographical area identifier and a predicate able to take one of two opposite values, and one may replace a current n-tuple associated with a user with a new n-tuple comprising the same user identifier and the same geographical area identifier as this current n-tuple but a predicate with a value opposite to the one of this current n-tuple, each time a crossing alert message relative to this user is generated; and/or

(f) the meeting opportunity alert message, transmitted to the mobile communication terminal of one user of a determined pair, may comprise the telephone number of the mobile communication terminal of the other user of this determined pair.

Other illustrative embodiments of the invention provide a communication system intended for providing meeting opportunity alert messages to users of mobile communication terminals associated with user identifiers and whose geographic locations can be determined. In accordance with one such illustrative embodiment of the invention, a communication system providing meeting opportunity alert messages to users of mobile communication terminals whose geographic locations can be determined, each of said users having an associated user identifier and a corresponding user profile, and wherein each of one or more predetermined geographical areas comprise one or more boundaries thereof, comprises:

(i) a first memory for storing at least a set of said predetermined geographical areas;

(ii) an alert module for analyzing the geographic locations of said mobile communication terminals in order to identify one or more boundary crossings associated with a given user identifier in response to a geographic location of the mobile communication terminal of the user corresponding to the given user identifier having changed from a first side of one of said boundaries of one of said predetermined geographical areas to a second side of said one of said boundaries of said one of said predetermined geographical areas;

(iii) an update module for updating a table of user presence, the table of user presence indicating, for each of a plurality of said users, whether that user is in a given one of said predetermined geographical s, the table of user presence being updated based on said identified boundary crossings; and

(iv) a control module for determining a pair of users both of which are present in a given geographical area based on the table of user presence, for comparing the user profiles associated with the users in said pair of users, and for generating a meeting opportunity alert message to the mobile communication terminal of at least one user of said pair of users which are present in the given geographical area, if the user profiles associated with the users in said pair of users match.

In accordance with various illustrative embodiments of the present invention, a communication system in accordance with invention may include additional characteristics considered separately or combined, such as, for example:

(a) its updating means may be arranged for updating the values of flags defining said table indications;

(b) its alert means may be arranged for generating a crossing alert message designating a user identifier each time the associated mobile communication terminal is entered into or has left out of the associated geographical area;

(c) in a variant its alert means may be arranged for generating a crossing alert message comprising a user identifier and a flag whose value is representative either of the entry of the corresponding user into his associated geographic location or of the leaving of the corresponding user out of his associated geographic location;

(d) its alert means may be arranged for storing a n-tuple for each user, each n-tuple comprising a user identifier and a geographical area identifier; and/or

(e) its control means may be arranged for generating a meeting opportunity alert message, intended for the mobile communication terminal of one user of a determined pair, which comprises the telephone number of the mobile communication terminal of the other user of this determined pair.

### BRIEF DESCRIPTION OF THE DRAWINGS

FIG. 1 shows an illustrative geographical area having a plurality of mobile terminals contained therein to which a method for providing meeting opportunity alert messages in accordance with an illustrative embodiment of the present invention may be applied.

FIG. 2 shows a communication system for providing meeting opportunity alert messages in accordance with an illustrative embodiment of the present invention.

### DETAILED DESCRIPTION OF THE PREFERRED EMBODIMENTS

The illustrative embodiments of the present invention provide for a new LBS (location-based service) which advantageously provides users (equipped with a localizable mobile or portable communication terminal) with alert messages when they have encountered an opportunity to meet someone located in their geographical vicinity and having a profile matching their own profile.

In the following description it will be considered that the user mobile communication terminals (Tijk—index i designates a terminal or user, index j designates an application and index k designates a geographical area) are mobile (or cellular) telephones connected to a mobile (or cellular) communication network (for instance a GMS, UMTS or a CDMA 2000 network, each of which is fully familiar to those of ordinary skill in the art). But it is important to notice that the invention is not limited to this type of mobile communication terminal. Indeed, the principles of the present invention may be applied to any communicating device capable at least to receive messages through an air interface from a communication network and whose geographic locations can be determined by a localization technique. So, it could be also a portable computer (or laptop), or a personal digital assistant (PDA), or else a mobile (or portable) equipment comprising (or coupled to) a GPS or A-GPS device. It could also be a part of a vehicle navigation device which comprises a wireless link to a network and possesses means to determine its geographic location. The geographic localization technique could comprise any method that allows mapping of a user to a certain geographic location or geographic location area based on a certain network-associated parameter and a lookup table such as the cell id (identifier) of a wireless network, the MAC and/or the IP address of the user's connected device. It can also comprise methods that allows mapping of a user to a geographical area based on the message context sent by the user's communication terminal to the wireless network. The message can be transmitted automatically by the communication terminal. The message can also be transmitted proactively by the user. The localization technique may also require that the user updates information on his geographic location by sending a message to a certain address (e.g. telephone number) with a certain location-specifying code such as a ZIP code, street address, latitude and longitude coordinates or names of points of interest (e.g. the Empire State Building). The localization technique may translate this location-specifying code into the user's geographic location via a lookup table.

Moreover, in the following description it will be considered that the localization technique used for determining the geographic locations of the user terminals (Tijk) is a network-based geolocation technique, such as, for instance, cell ID or cell-power triangulation. But it is important to notice that the invention is not limited to this type of localization technique. Indeed, it concerns any localization technique known from the man skilled in the art, and notably GPS or assisted GPS (A-GPS) technique.

So, in the following description it will be considered that the location coordinates of the user terminals (Tijk) are determined by the mobile network to which they are connected to and accessible into a user location module (ULM). But the location coordinates of the user terminals (Tijk) could be also determined by the user terminals themselves and transmitted to the user location module (ULM) through the mobile network.

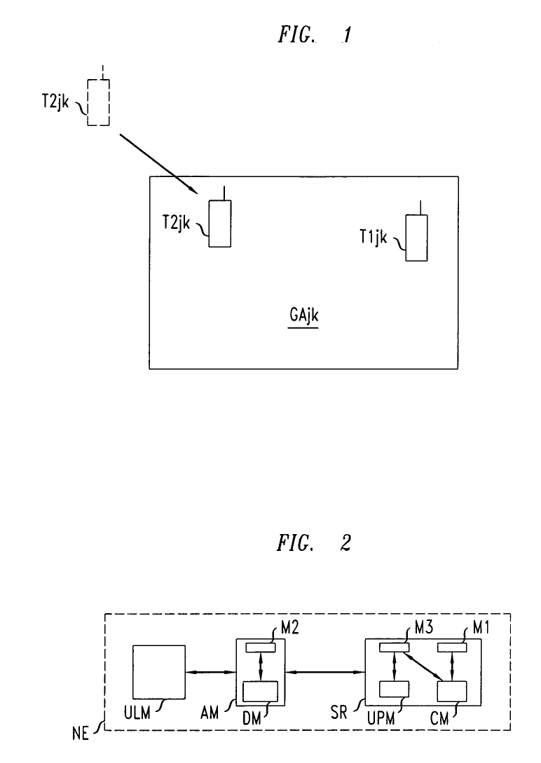

FIG. 1 shows an illustrative geographical area having a plurality of mobile terminals contained therein to which a method for providing meeting opportunity alert messages in accordance with an illustrative embodiment of the present invention may be applied. The figure shows a (bounded) area GAjk, which represents a specific geographical area k applicable to a specific application j. In addition, the figure shows a mobile terminal T1jk within the area GAjk, and mobile terminal T2jk entering the area GAjk. Therefore, the scenario illustrated in the figure advantageously offers a possible opportunity for a meeting between the users of terminals T1jk and T2jk, and thus, in accordance with certain illustrative embodiments of the present invention, alerts may be advantageously provided to said users of the mobile terminals.

FIG. 2 shows a communication system for providing meeting opportunity alert messages in accordance with an illustrative embodiment of the present invention. As illustrated therein, a communication system NE in accordance with one illustrative embodiment of the invention comprises at least a first storing means M1, an updating module UPM, a control module CM and an alert module AM.

As illustrated in the illustrative example of FIG. 2, all of the above mentioned elements of the communication system NE are grouped in one piece of network equipment, but, in other illustrative embodiments, this is not the case. Indeed, the first storing means M1, updating module UPM and control module CM may be parts of a server SR located in a first physical location, while the alert module AM is another piece of equipment (or a part of another piece of equipment) located in a second physical location which may be different from the first physical location.

Moreover in the illustrative example of FIG. 2, the above mentioned user location module ULM is part of the communication system NE, but, in accordance with other illustrative embodiments of the invention, this is not the case. Advantageously, however, the user location data stored into the user location module ULM is accessible to the alert module AM. Moreover, in accordance with some illustrative embodiments of the invention, the user location module ULM and the alert module AM may be part of a piece of network equipment different from the server SR.

In accordance with certain illustrative embodiments of the invention, at least one application Aj (j>0) is used to control the providing of meeting opportunity alert messages to a set of chosen user terminals Tijk (i>0, k>0). Illustratively, a portion (which may, for example, comprise software) of such an application Aj may be stored into a user terminal Tijk. The application Aj may, for example, execute on a different part of the communication system NE that does not comprise the terminal Tijk. In this case, the application would use the standard capabilities of the communication system NE to forward messages to the communication terminal NE (such as, for example, SMS or MMS, each fully familiar to those skilled in the art). It may also use standard capabilities provided by the communication system NE to obtain the location of the communication terminal Tijk, such as, for example, the Mobile Location Protocol (MLP) provided by the Gateway Mobile Location Center in GSM, and fully familiar to those of ordinary skill in the art.

Each terminal Tijk of a user Uijk may be associated with a user identifier Iijk, which can be, for example, be a communication identifier such as a phone number. Each set of terminals Tijk may be associated with a chosen group identifier GIjk. Each group identifier GIjk may be associated with a geographical area GAjk which is associated with a geographical area identifier and whose boundaries have known locations. Each group identifier GIjk may also be associated with a matrix Mjk which defines matching criteria between profiles of users (Uijk, Ui′jk) of pairs of users according to chosen rules.

Any type of user profile and any type of matching criteria may be employed. For example, a profile may define certain characteristics of a user (and possibly characteristics of other searched users) and/or a user company and/or a user participation in activities such as hobbies, sports etc., and/or a user participation in specified social networks such as clubs (and/or possibly company participation in activities and/or social networks of other searched users). For example, one may consider that there is a matching between two user profiles when they are associated with the same company or when the profile of a first user defines characteristics of a searched user and that the profile of a second user defines at least some chosen one of the defined characteristics of the searched user.

Each application Aj advantageously determines when a user Uijk of one of its associated groups GIjk is in or out of a chosen associated geographical area GAjk. Then, if there exists another user Ui′jk of the same associated group GIjk which is also in or out of the same associated geographical area GAjk, and if so, it is determined whether the profile of the user Ui′jk matches the profile of the user Uijk according to the associated matrix Mjk.

Returning to the illustrative system of FIG. 2, the first storing means M1 is adapted for storing, for each application Aj, each set of geographical (s) GAjk in correspondence with its associated group identifier and with its associated matrix Mjk. This first storing means M1 may, for example, be a memory or a database. The alert module AM is arranged for analyzing the geographic locations of each terminal Tijk which is associated with one of the applications Aj. As mentioned above, these geographic locations are accessible in the user location module ULM.

In particular, the illustrative system of FIG. 2 operates to compare the current (known) geographic location of a terminal Tijk with the known geographic locations of the boundaries of its associated geographical area GAjk. Specifically, the alert module AM advantageously knows the user identifiers Iijk associated with the terminals Tijk to be “watched over”, as well as the geographic locations of the boundaries of each geographical area GAjk associated with each terminal Tijk. This information (Iijk, GAjk) may be advantageously provided by the server SR and may be stored in n-tuples into a second storing means M2 of the alert module AM, as illustrated. (An “n-tuple” is a group of at least two pieces of information—i.e., n≧2—such as, in this example, a user identifier Iijk and the associated geographical area GAjk.)

These n-tuples (Iijk, GAjk, . . . ) may be stored in another component which is accessible to the alert module AM. For example, the second storing means M2, which may, for example, be a memory or a database, may store these n-tuples. The alert module AM may comprise, as illustrated, a detection module DM arranged to carry out the analysis and connected to the second storing means M2.

In an illustrative operation of the embodiment of FIG. 2, each time the detection module DM determines that a terminal Tijk has crossed the boundaries of its associated geographical area GAjk, it advantageously generates a crossing alert message which designates the associated user identifier Iijk for the server SR (and more precisely for the updating module UPM thereof). Note that the crossing may correspond either to the entry of a user Uijk into his or her associated geographical area GAjk or to the leaving of a user Uijk out of his or her associated geographical area GAjk. Thus, advantageously, a crossing alert message may indicate either that a user Uijk has entered into his associated geographical area GAjk or that a user Uijk has left out of his associated geographical area GAjk.

For example, the alert module AM may be arranged to generate a crossing alert message designating a user identifier Iijk each time the last geographic location of the associated terminal Tijk indicates that it has entered into or has left out of its associated geographical area GAijk. As such, the crossing alert messages do not need to comprise a flag with a value indicating if the crossing corresponds to an entry or a leaving. Advantageously, each terminal Tijk is initially considered to be out of its associated geographical area GAijk, and the first crossing alert message relative to a terminal Uijk is advantageously generated when this terminal Uijk enters into its associated geographical area GAijk.

In accordance with certain other illustrative embodiments of the present invention, the alert module AM may be arranged to generate a crossing alert message comprising a user identifier Iijk and a flag whose value is representative either of the entry of the associated terminal Tijk into its associated geographical area GAjk or of the leaving of the associated terminal Tijk out of its associated geographical area GAjk. In this case, there need not be any initial assumption relative to the position of each terminal Tijk compared with its associated geographical area GAjk.

In accordance with an illustrative embodiment of the present invention, in order to avoid multiple alerts and meeting opportunities when a user walks along the boundary of a geographical area GAjk, the meeting-opportunity application may advantageously delete the matrix element after the control module CM has provided a meeting-opportunity alert.

The updating module UPM advantageously intervenes each time it receives a crossing alert message from the alert module AM. This intervention consists, for example, in updating the presence indications of at least one table of user presence which indicates if users Uijk are in or out of their associated geographical area GAjk. More precisely, each time the updating module UPM receives a crossing alert message it advantageously reads the user identifier Iijk and the possible flag it contains and updates the (associated) table if the crossing alert message corresponds to a change of presence (in→out of or out of→in).

Note that one may use a single table for every user Uijk associated with every application Aj, or one table for each application Aj, or one table for each group of users GIjk of each application Aj, each in accordance with various illustrative embodiments of the present invention. The table(s) may be stored in a third storing means M3 of the server SR which is advantageously connected to both the updating module UPM and the control module CM. This third storing means M3 may, for example, be a memory or a database. In one illustrative embodiment of the invention, the storing means M1 and the storing means M3 may be two parts of the same storing means.

The control module CM advantageously intervenes each time the updating module UPM updates the table(s). Its intervention consists, for example, in analyzing the presence indications that are stored in the updated table in order to determine each pair (Uijk, Ui′jk) of users which are associated with a same group identifier GIjk and are present in their associated geographical area GAjk.

Each time the control module CM detects such a pair of users (Uijk, Ui′jk), it advantageously accesses the first storing means M1 in order to read the information stored in the matrix Mjk associated with the group GIjk to which the users Uijk and Ui′jk of this detected pair belong, in order to determine if there is a match between the respective profiles of the users Uijk and Ui′jk.

In the case where these profiles match, the control module CM advantageously generates meeting opportunity alert messages for the terminals Tijk and Ti′jk of the users Uijk and Ui′jk. The meeting opportunity alert condition may be communicated to the application Aj, which can then send the meeting opportunity alert message. In some illustrative embodiments of the present invention, some or all of the applications may be provided by various third party meeting opportunity companies (e.g., web pages), which can advantageously use the same meeting opportunity alert infrastructure described herein. Advantageously, the meeting opportunity alert messages may be sent to the terminals Tijk and Ti′jk through the air interface of their respective mobile networks, and this may be done, for example, by means of a SMS, MMS, WAP Push or an automated voice call (each of which is fully familiar to those of ordinary skill in the art). They may also be sent through other means, such as, for example, e-mail. Afterwards, the application may advantageously reset the matrix element for the corresponding users with respect to this region, or with respect to all overlapping geographic regions, in order to avoid multiple meeting opportunity alerts.

If the mobile terminals Tijk and/or Ti′jk run additional application software (e.g., clients), they can process the meeting opportunity alert message. For example, they can order a display of messages onto the screen of the terminal (Tijk or Ti′jk) and/or the diffusion of a voice message onto the loudspeaker thereof. Moreover, a more complex interaction between the meeting opportunity applications on the server and on the terminals may be initiated, such as, for example, a confirmation of a user's interest in taking advantage of meeting opportunity, a user providing additional information on a potential meeting, etc. When a terminal Tijk or Ti′jk receives a meeting opportunity alert message, the portion of the application Aj that it contains may advantageously process the received message. For example, it can order the display of a textual message onto the screen of the terminal and/or the diffusion of a voice message onto the loudspeaker of the terminal.

Note that the meeting opportunity alert message which is transmitted to a terminal Tijk (or Ti′jk) may, for example, advantageously comprise the telephone number of the other terminal Ti′jk (or Tijk) of the detected pair. In this case, the two users Uijk and Ui′jk might, for example, directly contact each other with their respective terminals Tijk and Ti′jk in order to exchange information, such as, for example, information intended to allow them to recognize each other at a meeting point. It is also possible that other information is exchanged between both users such as their specific geographic locations and/or their respective e-mail addresses and/or anonymous phone numbers or e-mail addresses, which will then advantageously provide both users with the capabilities to interact with each other while ensuring their individual privacy.

The alert module AM, and notably its detection module DM, and the server SR, and notably its updating module UPM and control module CM, may, for example, be implemented as software modules. However, they may instead be implemented as hardware modules or as a combination of hardware and software modules.

The illustrative communication system of FIG. 2, if applied to the illustrative geographical area having a plurality of mobile terminals contained therein as shown in FIG. 1, can be seen to illustrate a scenario in which a first user U1jk belonging to a group of users Gjk and having mobile terminal T1jk, is located in his associated geographical area GAjk, while (at the beginning) a second user U2jk belonging to the same group of users Gjk and having mobile terminal T2jk, is located out of this geographical area GAjk. When the second user U2jk (having mobile terminal T2jk) then enters into the geographical area GAjk, the alert module AM detects the crossing of the boundaries of the geographical area GAjk by the second user U2jk. Then it advantageously generates a crossing alert message designating the second user identifier I2jk in order to inform the server SR of the entry of the second user U2jk into his associated geographical area GAjk.

Next, the updating module UPM reads the user identifier I2jk and the possible flag contained in the received crossing alert message (see above), and advantageously updates the (associated) table because this crossing alert message corresponds to a change of presence (out of→in).

Next, the control module CM analyzes the presence indications that are stored in the updated table to determine if there exists a pair (Uijk, Ui′jk) of users associated with the same group identifier GIjk and present in their associated geographical area GAjk. Here, the first user U1jk and the second user U2jk are candidates to constitute such a detected pair. Thus, the control module CM accesses the first storing means M1 in order to read the information stored in the matrix Mjk associated with the group GIjk to which the users U1jk and U2jk belong. If the case where the profiles match, the control module CM generates meeting opportunity alert messages for terminals T1jk and T2jk of users U1jk and U2jk. These meeting opportunity alert messages may then be sent by the mobile network to the terminals T1jk and T2jk (connected to it) through its air interface.

Note that in accordance with various illustrative embodiments of the present invention, a variety of different architectures may be used. For example, the various modules as described above may either entirely reside in one centralized location such as one (or a set of) server(s), or they may be distributed over one (or a set of) centralized server(s), the users' terminals and the application server.

It is also possible, in accordance with various illustrative embodiments of the present invention, to allocate the functions of the user location module ULM, the second storing means M2, the alert module AM and the detection module DM on the communication terminal Tijk, and to allocate the remaining functions on one (or multiple) central server(s). In this case, the terminal Tijk may hold the geographical s GAjk information. This approach may be especially advantageous when the terminal Tijk possesses autonomous localization techniques, such as that provided by GPS or A-GPS (assisted GPS), for example, since such terminals can perform frequent location measurements and boundary crossing evaluations without using the wireless interface. (The wireless interface will only then need to be used when a boundary crossing event occurs or when the geographical s GAjk are updated.) In such an illustrative embodiment of the invention, it may be of further advantage to add a user-specific index to the geographical s (i.e., GAijk) in order to reduce the quantity of geographical s that need to be held on the phone.

In another illustrative embodiment of the present invention, the functions of the updating module UPM, the first storing means M1, the third storing means M3 and the control module CM may, for example, be integrated into the application running on one (or multiple) server(s), and the alert module AM, the detection module DM and the second storing means M2 may then be run by a client on the terminal Tijk. While such an approach may require replication of clients and application servers for each application, it advantageously allows tailoring the modules' functions to the specific demands of each application.

In another illustrative embodiment of the present invention, the functions of the updating module UPM, the first storing means M1, the third storing means M3 and the control module CM may, for example, reside on one (or a set of) server(s) that operate(s) independently of the applications. This advantageously allows running meeting opportunity message alerts as a separate service to support multiple different applications. In this approach, the remaining functions of the user location module ULM, the alert module AM and the detection module DM may either reside on the terminal Tijk, or they may be combined onto the central (set of) server(s). The former is advantageous for terminals Tijk with autonomous localization capabilities. The latter has the advantage that no separate client has to be run on the terminal Tijk.

### Addendum to the Detailed Description

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope. In addition, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

What is claimed is:

1. A method for providing meeting opportunity alert messages to users of mobile communication terminals whose geographic locations can be determined, each of said users having an associated user identifier and a corresponding user profile, and wherein each of one or more predetermined geographical areas comprise one or more boundaries thereof, the method comprising the steps of:
identifying one or more boundary crossings, each identified boundary crossing associated with a given user identifier and identified in response to a geographic location of the mobile communication terminal of the user corresponding to the given user identifier having changed from a first side of one of said boundaries of one of said predetermined geographical areas to a second side of said one of said boundaries of said one of said predetermined geographical areas;
updating a table of user presence, the table of user presence indicating, for each of a plurality of said users, whether that user is in a given one of said predetermined geographical s, the table of user presence being updated based on said identified boundary crossings;
determining a pair of users both of which are present in a given geographical area based on the table of user presence;
comparing the user profiles associated with the users in said pair of users; and
generating a meeting opportunity alert message, for transmission to the mobile communication terminal of at least one user of said pair of users which are present in the given geographical area, if the user profiles associated with the users in said pair of users match.

2. The method of claim 1 wherein said user profiles associated with said users comprise a group identifier, and wherein the step of comparing the user profiles associated with the users in said pair of users comprises comparing the group identifiers comprised therein.

3. The method of claim 2 wherein each of the predetermined geographical areas is associated with one of said group identifiers, and wherein said step of identifying said boundary crossings only identifies said boundary crossings when they are associated with a given user identifier and a boundary of a geographical area associated with an identical group identifier.

4. The method of claim 1 wherein said step of comparing the user profiles is performed with use of a matrix having entries indicating matches between said user profiles associated with pairs of said users.

5. The method of claim 1 wherein each of said geographical areas is associated with one of a plurality of predetermined applications, and wherein said table of user presence is updated for only a given one of said applications.

6. The method of claim 1 wherein the meeting opportunity alert message, generated for transmission to the mobile communication terminal of at least one user of said pair of users which are present in the given geographical area, comprises a mobile phone number associated with the mobile communication terminal of the other user of said pair of users.

7. A communication system for providing meeting opportunity alert messages to users of mobile communication terminals whose geographic locations can be determined, each of said users having an associated user identifier and a corresponding user profile, and wherein each of one or more predetermined geographical areas comprise one or more boundaries thereof, the communication system comprising:
a processor, wherein the processor is adapted to:
identify one or more boundary crossings, each identified boundary crossing associated with a given user identifier and identified in response to a geographic location of the mobile communication terminal of the user corresponding to the given user identifier having changed from a first side of one of said boundaries of one of said predetermined geographical areas to a second side of said one of said boundaries of said one of said predetermined geographical areas,
update a table of user presence, the table of user presence indicating, for each of a plurality of said users, whether that user is in a given one of said predetermined geographical s, the table of user presence being updated based on said identified boundary crossings,
determine a pair of users both of which are present in a given geographical area based on the table of user presence, and
compare the user profiles associated with the users in said pair of users; and
a transmitter which transmits a meeting opportunity alert message to the mobile communication terminal of at least one user of said pair of users which are present in the given geographical area, if the user profiles associated with the users in said pair of users match.

8. The communication system of claim 7 wherein said user profiles associated with said users comprise a group identifier, and wherein the processor is adapted to compare the user profiles associated with the users in said pair of users by comparing the group identifiers comprised therein.

9. The communication system of claim 8 wherein each of the predetermined geographical areas is associated with one of said group identifiers, and wherein the processor is adapted to identify said boundary crossings by only identifying said boundary crossings when they are associated with a given user identifier and a boundary of a geographical area associated with an identical group identifier.

10. The communication system of claim 7 wherein the processor is adapted to compare the user profiles with use of a matrix having entries indicating matches between said user profiles associated with pairs of said users.

11. The communication system of claim 7 wherein each of said geographical areas is associated with one of a plurality of predetermined applications, and wherein the processor is adapted to update the table of user presence for only a given one of said applications.

12. The communication system of claim 7 wherein the meeting opportunity alert message, transmitted to the mobile communication terminal of one user of said pair of users, includes a mobile phone number associated with the mobile communication terminal of the other user of said pair of users.

13. A communication system for providing meeting opportunity alert messages to users of mobile communication terminals whose geographic locations can be determined, each of said users having an associated user identifier and a corresponding user profile, and wherein each of one or more predetermined geographical areas comprise one or more boundaries thereof, the communication system comprising:
a first memory for storing at least a set of said predetermined geographical areas;
an alert module for analyzing the geographic locations of said mobile communication terminals in order to identify one or more boundary crossings associated with a given user identifier in response to a geographic location of the mobile communication terminal of the user corresponding to the given user identifier having changed from a first side of one of said boundaries of one of said predetermined geographical areas to a second side of said one of said boundaries of said one of said predetermined geographical areas;
an update module for updating a table of user presence, the table of user presence indicating, for each of a plurality of said users, whether that user is in a given one of said predetermined geographical s, the table of user presence being updated based on said identified boundary crossings; and
a control module for determining a pair of users both of which are present in a given geographical area based on the table of user presence, for comparing the user profiles associated with the users in said pair of users, and for generating a meeting opportunity alert message to the mobile communication terminal of at least one user of said pair of users which are present in the given geographical area, if the user profiles associated with the users in said pair of users match.

14. The communication system of claim 13 wherein said user profiles associated with said users comprise a group identifier, and wherein the control module compares the user profiles associated with the users in said pair of users by comparing the group identifiers comprised therein.

15. The communication system of claim 14 wherein each of the predetermined geographical areas is associated with one of said group identifiers, and wherein the alert module identifies said boundary crossings by only identifying said boundary crossings when they are associated with a given user identifier and a boundary of a geographical area associated with an identical group identifier.

16. The communication system of claim 13 wherein the control module compares the user profiles with use of a matrix having entries indicating matches between said user profiles associated with pairs of said users.

17. The communication system of claim 13 wherein each of said geographical areas is associated with one of a plurality of predetermined applications, and wherein the update module updates the table of user presence for only a given one of said applications.

18. The communication system of claim 13 wherein the meeting opportunity alert message, generated for transmission to the mobile communication terminal of one user of said pair of users, includes a mobile phone number associated with the mobile communication terminal of the other user of said pair of users.
